(19) United States
(12) Patent Application Publication
(10) Pub. No.: US 2022/0355854 A1
(43) Pub. Date: Nov. 10, 2022

(54) SELF-CENTERING DOUBLE ENDED HYDRAULIC STEERING CYLINDER THAT USES NO ELECTRONICS

(71) Applicant: Ronald Gene Timmons, Newberry, FL (US)

(72) Inventor: Ronald Gene Timmons, Newberry, FL (US)

(21) Appl. No.: 17/661,993

(22) Filed: May 4, 2022

Related U.S. Application Data
(60) Provisional application No. 63/183,819, filed on May 4, 2021.

(51) Int. Cl. B62D 5/12; B62D 5/06

(52) U.S. Cl. CPC B62D 5/12; B62D 5/062

(57) ABSTRACT

A self-centering double ended hydraulic steering cylinder that uses no electronics and a method of making the same. The self-centering double ended hydraulic steering cylinder has an elongated housing having end caps at opposing ends of the housing, wherein first and second rod portions are slidably disposed through the end caps. A piston is slidably disposed within the housing, the first and second rod portions extending from the piston, the piston defining first and second hydraulic fluid chambers within the housing. On each opposing end cap is a coiled spring for urging the piston toward a neutral position with the housing. A miniscule passage is formed into the piston so that hydraulic fluid flow through the piston that allows the springs to push the piston back to the neutral position.

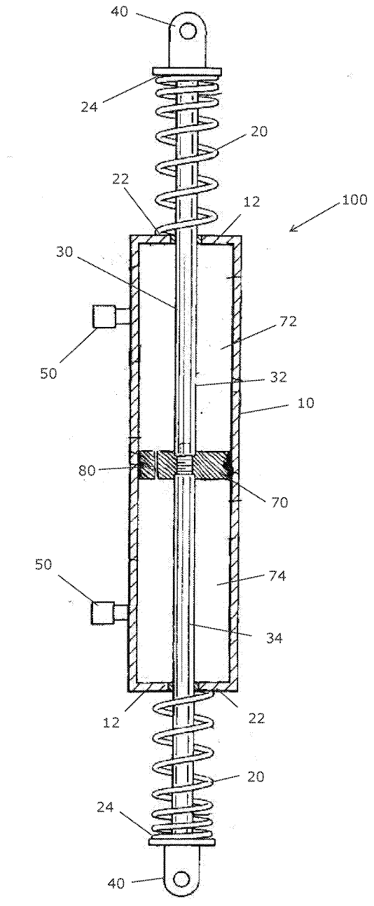

### CROSS-REFERENCE TO RELATED APPLICATION

This application claims the benefit of priority of U.S. provisional application No. 63/183,819, filed 4 May 2021, the contents of which are herein incorporated by reference.

### BACKGROUND OF THE INVENTION

The present invention relates to steering systems and, more particularly, a self-centering double ended hydraulic steering cylinder that uses no electronics.

Steering mechanisms are inherently vulnerable to failure due to their complicated electronics that monitor the position and return the steering system to the center or neutral position after a turn. Electronics, generally, are expensive and hard to manufacturer and install. Steering electronic components, in particular, are expensive and costly to replace. Electronic self-centering devices have multiple electronic parts and so if one part fails the steering system is useless, as is the vehicle.

The electronics and sensors associated with the current steering systems are prone to failure due to vulnerable wiring and fragile components, that may be negatively impacted by the speed, acceleration, and road conditions the vehicle is experiencing at any given moment of being driven.

In sum, electronic components do not hold up well against the elements and rough driving conditions when a single electronic component is compromised, resulting in the whole system being disabled and deemed useless.

As can be seen, there is a need for a self-centering double ended hydraulic steering cylinder that uses no electronics, thereby simplifying manufacturing and installation while improving reliability.

The present invention eliminates the unreliability and vulnerability associated with damaged or faulty electronic parts of self-centering steering mechanisms. As a result, the steering system embodied in the present invention is impervious to the elements in which most steering mechanisms reside and provides unparalleled steering reliability that is guaranteed to self-center even under catastrophic steering system failure.

### SUMMARY OF THE INVENTION

In one aspect of the present invention, a self-centering steering device devoid of electronics, the device includes the following: a housing having end caps at opposing ends of the housing, first and second rod portions being slidably disposed through the end caps; a piston slidably disposed within the housing, the first and second rod portions extending from the piston, the piston defining first and second hydraulic fluid chambers within the housing, wherein the piston has a seal around a periphery thereof to prevent fluid flowing therearound between the first and second chambers; and on each opposing end cap is a spring for urging the piston toward a neutral position with the housing; and the piston having a single miniscule passage disposed therethrough, fluidly connecting the first and second hydraulic fluid chambers in such a way that hydraulic fluid flow through the piston urges the springs to push the piston back to the neutral position.

In another aspect of the present invention, the single miniscule passage has a uniform diameter of less than nine one-hundredth of an inch, and wherein a location of the single miniscule passage was predetermined prior to its formation.

In yet another aspect of the present invention, a method of making a self-centering steering device devoid of electronics from a double ended hydraulic steering cylinder, includes providing the above-mentioned double ended hydraulic steering cylinder sans miniscule hole and then forming the single miniscule hole. Similarly, this method can improve a double ended hydraulic steering cylinder,

These and other features, aspects and advantages of the present invention will become better understood with reference to the following drawings, description and claims.

### BRIEF DESCRIPTION OF THE DRAWINGS

The sole FIGURE is top plan view in section of an exemplary embodiment of a double ended steering cylinder of the present invention, illustrating its internal configuration when in its neutral position.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a self-centering double ended hydraulic steering cylinder that uses no electronics.

The double ended steering cylinder 100 may have an elongated cylindrical body 10 having end caps at opposite ends thereof. A piston 70 is slidable within the cylindrical body, and thereby defines a forward chamber 72 and a rearward chamber 74 that normally contain hydraulic fluid, the piston 70 having a piston seal around its periphery to prevent fluid flow around the piston 70 between the forward and rearward chambers 72 and 74. Ports 50 are provided on the cylinder body for connecting the forward and rearward chambers 72 and 74 to a hydraulic pump (not shown).

The double ended steering cylinder 100 may include helical compression springs 20 coaxially around the front and rear rod portions, respectively. The compression springs 20 may be confined between the cylinder's end caps and annual flanges 24 fixed around the distal ends of the front and rear rod portions, respectively. The opposing springs 20 normally bias the piston 70 so that the piston 70 is centered within the cylinder body 10.

The double ended steering cylinder 100 is further modified to include one miniscule passage 80 through the piston 70. The miniscule passage 80 has a diameter less than nine one-hundredth of an inch. Thus, essentially all hydraulic flow within the cylinder 100 is blocked from the forward chamber to the rearward chamber but for the miniscule passage 80, which enables fluid leakage between the forward and rearward chambers.

The minuscule passage 80 can be drilled or otherwise formed through the piston 70 of the double ended hydraulic steering cylinder, enabling the cylinder (when hydraulically pressurized) to create enough pressure to compress the springs 20 and move the piston to the full left or right position when steering is performed. Then, when hydraulic pressure is released, the minuscule passage 80 critically allows hydraulic fluid flow through the piston 70 that allows the coil springs to push the piston 70 back to the center, neutral position.

A method of making the present invention may include the following. A manufacture may purchase a double ended hydraulic steering cylinder and disassemble the hydraulic cylinder. The manufacturer may take the piston out of cylinder and drill a minuscule hole or passage through the piston that does not interfere with the normal functions of the piston, then reassemble the cylinder. The manufacturer may build pad mounts for both ends of coil springs to attach the coil springs to the opposing ends of the double ended steering cylinder.

A method of using the present invention may include the following. A user may install the double ended hydraulic steering cylinder 10 by affixing the opposing mounting assemblies to a rigid portion of the vehicle. Then the user may operatively associate the right and left steering linkages to the right and left linkage connector 50, respectively. As a result of the present invention's design, time spent on wiring has been eliminated, cutting installation time in half. Moreover, the non-electronic design ensures reliability and durability in harsh environments.

Furthermore, the present invention may be used for any automotive, industrial, or agricultural applications.

As used in this application, the term “about” or “approximately” refers to a range of values within plus or minus 10% of the specified number. And the term “substantially” refers to up to 90% or more of an entirety. Recitation of ranges of values herein are not intended to be limiting, referring instead individually to any and all values falling within the range, unless otherwise indicated, and each separate value within such a range is incorporated into the specification as if it were individually recited herein. The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A self-centering steering device devoid of electronics, the device comprising:
a housing having end caps at opposing ends of the housing, first and second rod portions being slidably disposed through the end caps;
a piston slidably disposed within the housing, the first and second rod portions extending from the piston, the piston defining first and second hydraulic fluid chambers within the housing;
on each opposing end cap is a spring for urging the piston toward a neutral position with the housing; and
the piston having a single miniscule passage disposed therethrough, fluidly connecting the first and second hydraulic fluid chambers in such a way that hydraulic fluid flow through the piston urges the springs to push the piston back to the neutral position.

2. The device of claim 1, wherein the single miniscule passage has a uniform diameter of less than nine one-hundredth of an inch.

3. The device of claim 2, further comprising a seal around a periphery of the piston to prevent fluid flowing therearound between the first and second chambers.

4. The device of claim 3, wherein a location of the single miniscule passage was predetermined prior to its formation.

5. A method of making a self-centering steering device devoid of electronics from a double ended hydraulic steering cylinder, the method comprising:
providing the double ended hydraulic steering cylinder comprising:
an elongated cylindrical housing having end caps at opposing ends of the housing, first and second rod portions being slidably disposed through the end caps;
a piston slidably disposed within the housing, the first and second rod portions extending from the piston, the piston defining first and second hydraulic fluid chambers within the housing; and
on each opposing end cap is a spring for urging the piston toward a neutral position with the housing; and
forming a single miniscule passage through the piston,
thereby fluidly connecting the first and second hydraulic fluid chambers in such a way that hydraulic fluid flow through the piston urges the springs to push the piston back to the neutral position.

6. The method of claim 5, wherein the miniscule passage has a uniform diameter of less than nine one-hundredth inch.

7. A method of improving a double ended hydraulic steering cylinder, wherein the double ended hydraulic steering cylinder comprises an elongated cylindrical housing having end caps at opposing ends of the housing, first and second rod portions being slidably disposed through the end caps; and a piston slidably disposed within the housing, the first and second rod portions extending from the piston, the piston defining first and second hydraulic fluid chambers within the housing, the method comprising:
forming a single miniscule passage through the piston.

8. The method of claim 7, wherein the miniscule passage has a uniform diameter of less than nine one-hundredth inch.
